(19) United States
(12) Patent Application Publication
(10) Pub. No.: US 2015/0183121 A1
(43) Pub. Date: Jul. 2, 2015

(54) WINDOW SLAT CUTTING DEVICE

(71) Applicant: CHING FENG HOME FASHIONS CO., LTD., Fuxing Shiang (TW)

(72) Inventors: SHENG-YING HSU, Fuxing Shiang (TW); WU-CHUNG NIEN, Fuxing Shiang (TW)

(21) Appl. No.: 14/184,686

(22) Filed: Feb. 19, 2014

(30) Foreign Application Priority Data
Dec. 30, 2013 (TW) 102224758

(51) Int. Cl. B26B 29/06; B26D 7/01; B26D 7/00

(52) U.S. Cl. CPC B26B 29/06; B26D 7/0006; B26D 7/01

(57) ABSTRACT

A slat cutting device includes a positioning unit having two parallel side boards with a back board connected to two longitudinal sides of the side boards, and a base board is connected between the two side boards so as to define a reception recess between the two parallel side boards, the back board and the base board. A cutting unit has an operation board and two guide boards are perpendicularly connected to two sides of the operation board so as to define a space defined between the two guide boards and the operation board. Each guide board has a longitudinal cutting slit and a blade movably extends through the cutting slits to cut the slats which have one end contacting against the back board. By pulling the operation board, the desired length of the slats between the back board and the cutting unit is adjusted.

### BACKGROUND OF THE INVENTION

1. Fields of the invention

The present invention relates to a cutting device, and more particularly, to a Do-It-Yourself window slat cutting device.

2. Descriptions of Related Art

The conventional window curtains comprises multiple slats which are able to be adjusted their angles. Some customers are interested in installing the slats by themselves so as to meet the sizes and shapes of their windows. The slats are purchased from the market and cut them according to the length of the windows. There is an electric slat cutting device in the market, but it is expensive. Usually, once the slats are installed, the electric slat cutting device will not be used for a long period of time. The expense for purchasing the electric slat cutting device becomes a burden for some customers.

The present invention intends to provide a slat cutting device which allows the customers to cut the slats by themselves and the slat cutting device improves the shortcomings mentioned above.

### SUMMARY OF THE INVENTION

The present invention relates to a slat cutting device and comprises a positioning unit and a cutting unit. The positioning unit has two parallel side boards, and a back board is connected between two side boards so that a reception recess is defined between the two parallel side boards and the back board. The cutting unit has an operation board located horizontally and has a first end and a second end. Two guide boards are perpendicularly connected to two sides of the second end of the operation board. A space is defined between the two guide boards. Each guide board has a longitudinal cutting slit defined therethrough and communicating the top of the guide board. An anvil is located between the two guide boards and on the second end of the operation board. The anvil does not intersect the two cutting slits. The space is located corresponding to the reception recess. Two ends of slats are respectively accommodated in the reception recess and the space. The slats contact the back board. A blade movably extends through the cutting slits to cut the slats.

Preferably, the two side boards are connected to two sides of a base board. A surface board is located on the base board and located between the two side boards. The reception recess is defined between the side boards, the back board and the surface board.

Preferably, the back board has its underside thereof fixed to the base board. The back board is connected to two longitudinal sides of the two side boards. An end of the surface board contacts the back board.

Preferably, the first end of the operation board protrudes beyond the guide boards so as to be held by a user.

Preferably, the cutting slits are ended at the top surface of the second end of the operation board. The first end face of the anvil is in flush with the second end of the operation board, and the second end face of the anvil is not beyond the cutting slits.

The primary object of the present invention is to provide a slat cutting device which does not need electric power and comprises a positioning unit and a cutting unit. The slats are put between the positioning unit and the cutting unit. The slats are cut by a blade movable in the cutting slits of the cutting unit. The cutting device is less expensive and can cut the slats into desired lengths.

Another object of the present invention is to provide a slat cutting device wherein the positioning unit and the cutting unit are two individual units which are compact and easily carried and stored.

The positioning unit and the cutting unit are composed of by boards which are easily assembled and have lower cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the slat cutting device of the present invention;

FIG. 2 is another exploded view of the slat cutting device of the present invention;

FIG. 3 is a front view of the slat cutting device of the present invention, and

FIGS. 4 to 6 show steps of the cutting the slats by using the slat cutting device of the present invention.

### DETAILED DESCRIPTION OF THE PREFERRED EMBODIMENT

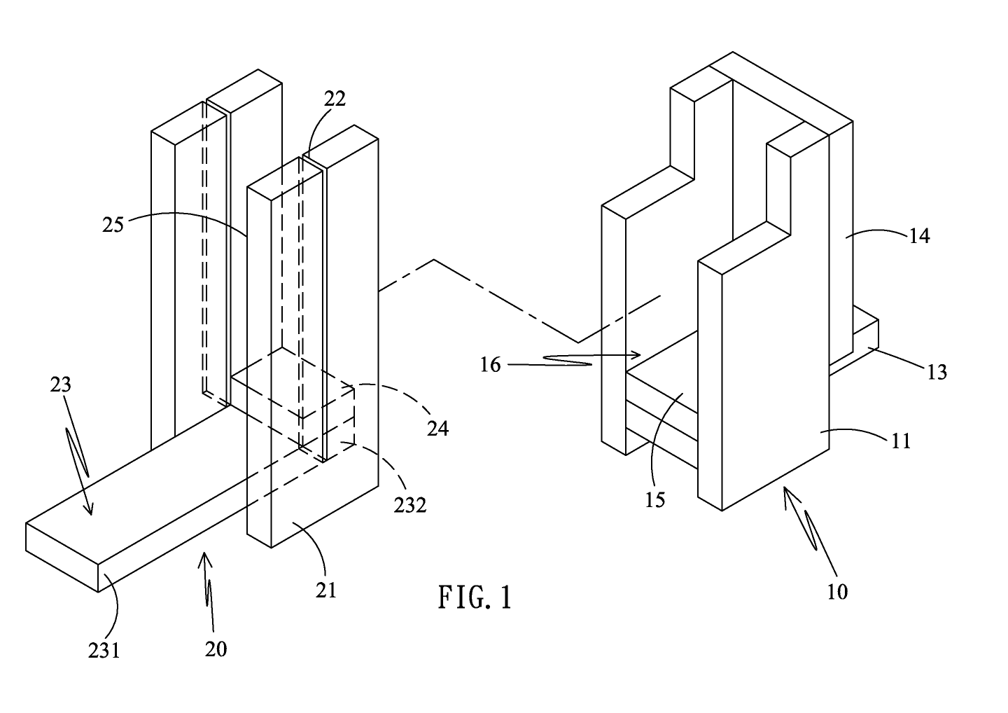

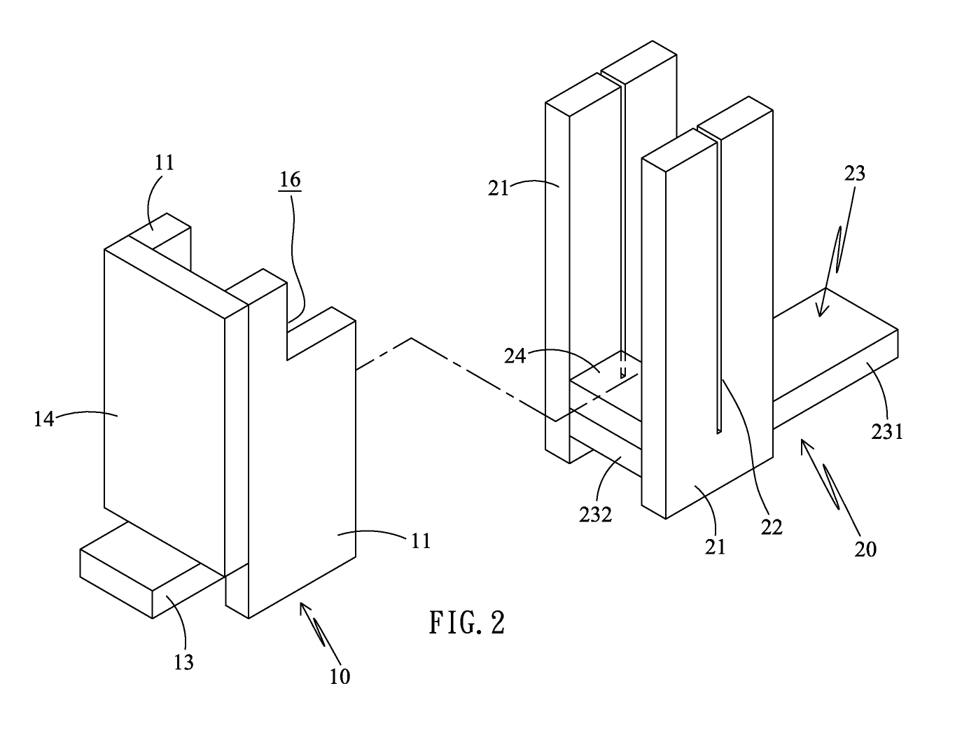

Referring to FIGS. 1 and 2, the slat cutting device of the present invention comprises a positioning unit 10 and a cutting unit 20. The positioning unit 10 comprises two parallel side boards 11, and a back board 14 connected to the two longitudinal sides of the two side boards 11. The two side boards 11 are connected to two sides of a base board 13 and a surface board 15 is located on the base board 13 and located between the two side boards 11. The underside of the back board 14 has is fixed to the base board 13. A reception recess 16 is defined between the side boards 11, the back board 14 and the surface board 15. An end of the surface board 15 contacts the back board 14.

The cutting unit 20 has an operation board 23 located horizontally and the operation board 23 has a first end 231 and a second end 232. Two guide boards 21 are perpendicularly connected to two sides of the second end 232 of the operation board 23. A space 25 is defined between the two guide boards 21. Each guide board 21 has a longitudinal cutting slit 22 defined therethrough and communicating the top of the guide board 21. The cutting slits 22 are ended at the top surface of the second end 232 of the operation board 23. An anvil 24 is located between the two guide boards 21 and on the second end 232 of the operation board 23. The anvil 24 does not intersect the two cutting slits 22. The first end face of the anvil 24 is in flush with the second end 232 of the operation board 23, and the second end face of the anvil 24 is not beyond the cutting slits 22. The first end 231 of the operation board 23 protrudes beyond the guide boards 21 so as to be held by a user. The space 25 is located corresponding to the reception recess 16.

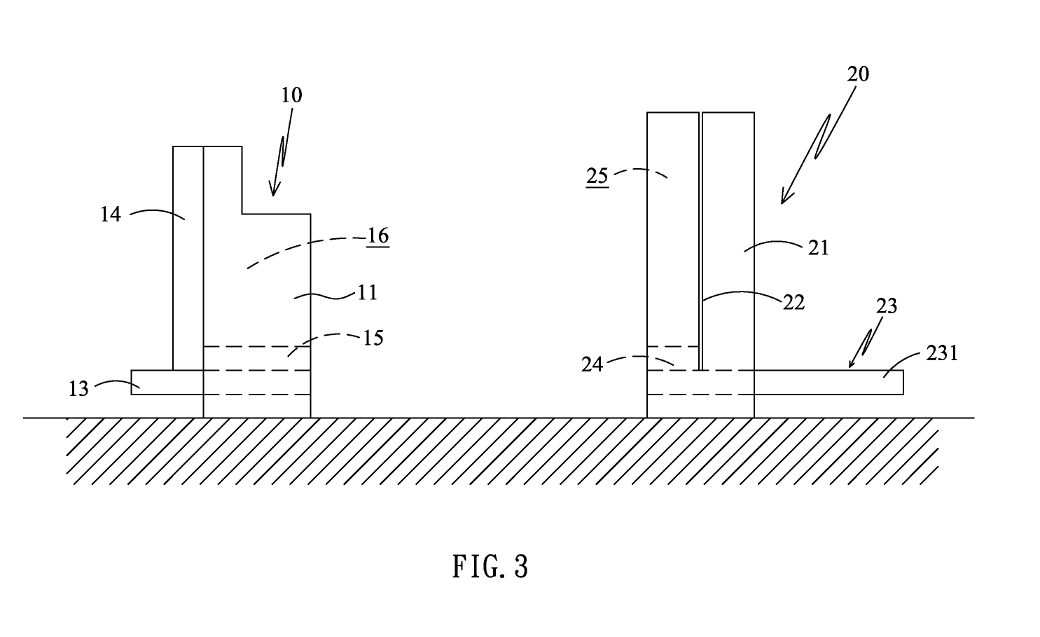

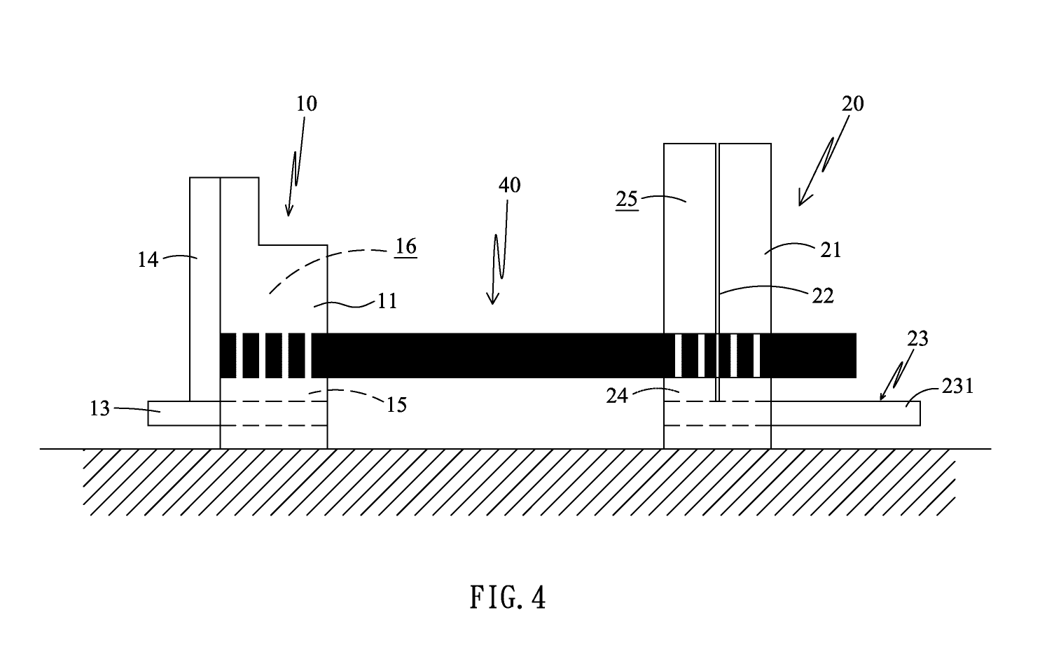

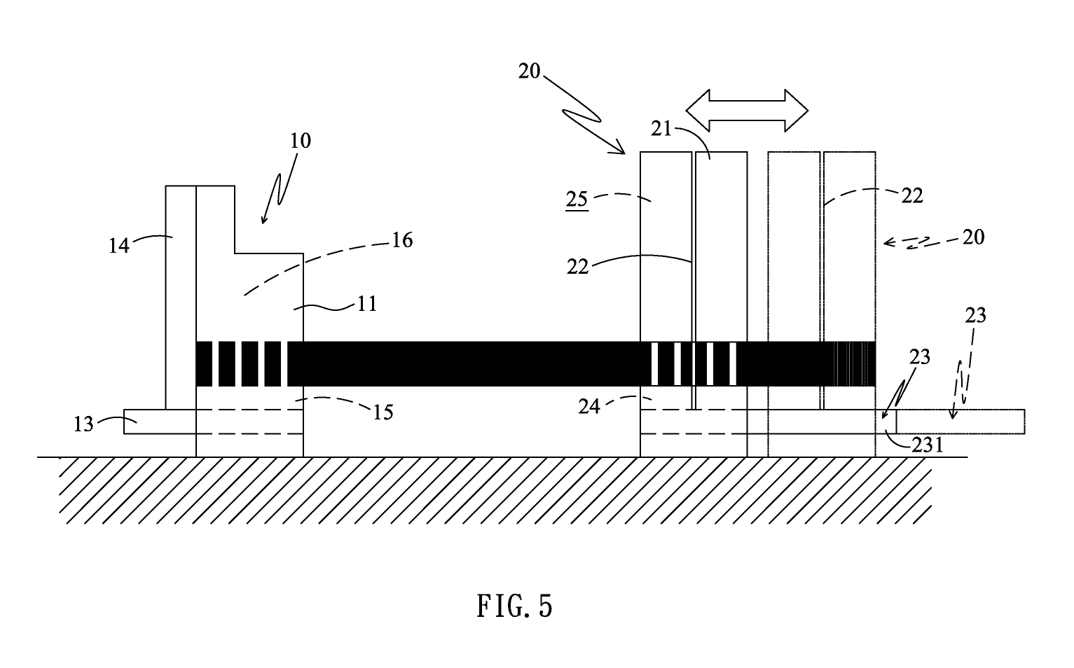

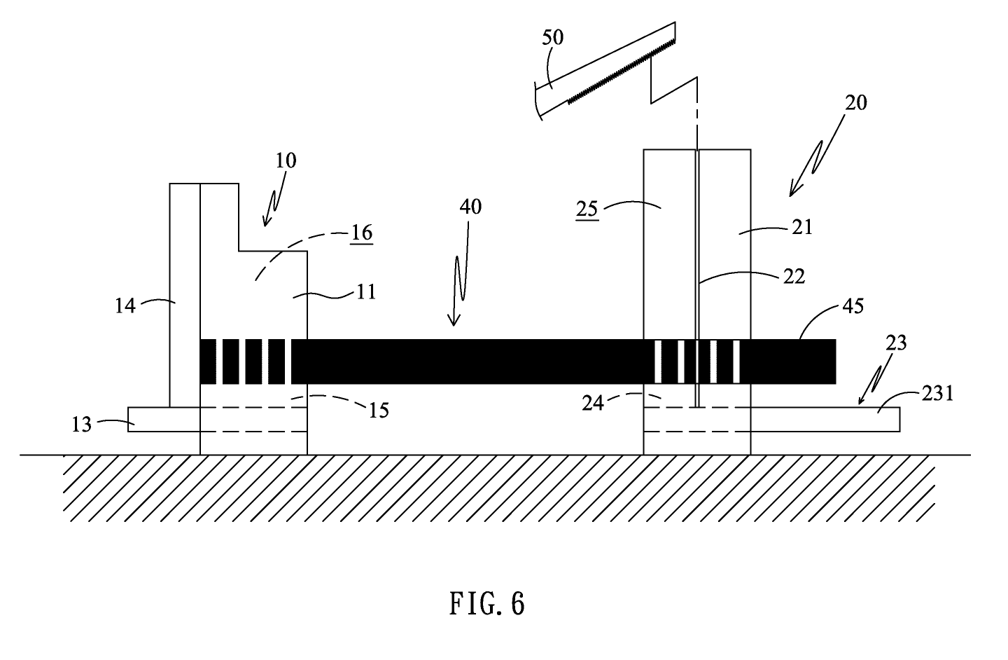

As shown in FIGS. 3 to 6, when cutting the slats 40, the two ends of slats 40 respectively accommodated in the reception recess 16 and the space 25, wherein one ends of the slats 40 are supported on the surface board 15 and contact against the back board 14. The other ends of the slats 40 are inserted in the space 25 and put on the anvil 24.

The user holds the first end 231 of the operation board 23 and moves the cutting unit 20 along the slats 40 until the cutting slits 22 are located at the desired length of the slats 40. The exceeded portions 45 of the slats 40 protrude out from the space 25. The blade 50 movably extends through the cutting slits 22 to cut the slats 40. The exceeded portions 45 of the slats 40 are cut and collected. The same steps can be operated to cut the other ends of the slats 40 to obtain the desired length of the slats 40.

While we have shown and described the embodiment in accordance with the present invention, it should be clear to those skilled in the art that further embodiments may be made without departing from the scope of the present invention.

What is claimed is:

1. A slat cutting device comprising:
a positioning unit having two parallel side boards, a back board connected between two side boards, a reception recess defined between the two parallel side boards and the back board, and
a cutting unit having an operation board located horizontally, the operation board having a first end and a second end, two guide boards perpendicularly connected to two sides of the second end of the operation board, a space defined between the two guide boards, each guide board having a longitudinal cutting slit defined therethrough and communicating a top of the guide board, an anvil located between the two guide boards and on the second end of the operation board, the anvil being not intersecting the two cutting slits, the space located corresponding to the reception recess, two ends of slats respectively accommodated in the reception recess and the space, the slats contacting the back board, and
a blade movably extending through the cutting slits to cut the slats.

2. The device as claimed in claim 1, wherein the two side boards are connected to two sides of a base board, a surface board is located on the base board and located between the two side boards, the reception recess is defined between the side boards, the back board and the surface board.

3. The device as claimed in claim 2, wherein the back board has an underside thereof fixed to the base board, the back board is connected to two longitudinal sides of the two side boards, an end of the surface board contacts the back board.

4. The device as claimed in claim 1, wherein the first end of the operation board protrudes beyond the guide boards so as to be held by a user.

5. The device as claimed in claim 1, wherein the cutting slits are ended at a top surface of the second end of the operation board, a first end face of the anvil is in flush with the second end of the operation board, a second end face of the anvil is not beyond the cutting slits.
